(19) United States
(12) Patent Application Publication
(10) Pub. No.: US 2022/0400005 A1
(43) Pub. Date: Dec. 15, 2022

(54) GENERATING PRIME NUMBERS

(71) Applicant: Hewlett-Packard Development Company, L.P., Spring, TX (US)

(72) Inventors: Joshua Serratelli Schiffman, Washington, DC (US); Thalia May Laing, Bristol (GB); David Plaquin, Bristol (GB)

(73) Assignee: Hewlett-Packard Development Company, L.P., Spring, TX (US)

(21) Appl. No.: 17/761,712

(22) PCT Filed: Oct. 16, 2019
(86) PCT No.: PCT/US2019/056478

§ 371 Date: Mar. 18, 2022

(51) Int. Cl. H04L 9/08

(52) U.S. Cl. CPC H04L 9/0869; H04L 9/0825

(57) ABSTRACT

In an example a method includes retrieving, from a persistent memory, a previously-identified counter value corresponding to an iteration of a prime number generation procedure that previously produced a verified prime number. The method further includes re-generating, using processing circuitry implementing a deterministic prime number calculator and with the previously-identified counter value as an input to the deterministic prime number calculator, the verified prime number.

### BACKGROUND

Certain cryptographic systems such as the Rivest-Shamir-Adleman, RSA, cryptographic system use prime numbers to generate cryptographic keys. As part of the procedure for generating a cryptographic key, candidate prime numbers may be subject to a primality test to verify whether or not a candidate prime number is prime. A verified prime number may then be used to generate the cryptographic key.

### BRIEF DESCRIPTION OF DRAWINGS

Non-limiting examples will now be described with reference to the accompanying drawings, in which:

FIG. 1 is a flowchart of an example method of re-generating a prime number;

FIG. 2 is a flowchart of an example method of re-generating at least one of a prime number and a key;

FIG. 3 is a simplified schematic illustration of an example apparatus for implementing certain methods;

FIG. 4 is a simplified schematic illustration of an example apparatus for implementing certain methods; and

FIG. 5 is a simplified schematic illustration of an example machine-readable medium associated with a processor.

### DETAILED DESCRIPTION

Cryptographic key generation and other processes that involve identifying large prime numbers (e.g., of order 1024 bits) may be considered to be relatively slow since the process for identifying large prime numbers may involve multiple iterations of a prime number testing procedure. In some examples, a different candidate prime number is generated in each iteration of the procedure and the candidate prime number is tested for primality until a verified prime number has been identified. Although the prime number generation procedure may be deterministic in that the same prime number may be generated based on the same starting point (e.g., seed), the procedure may be considered to be probabilistic since it is not known in advance how many candidate prime numbers will be tested before a candidate prime number is verified as being prime.

A computing device such as a trusted platform module, TPM, that generates a cryptographic key such as an RSA key may have certain specifications in terms of processing power and/or memory to generate to the key due to the size of the prime numbers underpinning the key and the probabilistic nature of the prime number identification procedure. In some applications where a key is to be provided within a specified timeframe, the specification of the computing device may be appropriately selected to meet the specified timeframe. In some examples, the computing device may be provided with sufficient computational power in order to generate an RSA key on demand (e.g., as part of a cryptographic operation). In some examples, the computing device may have a sufficient memory allocation for storing an RSA key so that the key can be supplied on demand (e.g., as part of a cryptographic operation). Certain cryptographic operations such as encryption and signature provision may be implemented using a cryptographic key generated by a computing device.

Certain cryptosystems such as the RSA cryptosystem are referred to as asymmetric since they provide both a public and private key. In some examples, the public key may be used to encrypt a message to be sent from a computing device to a third party entity for decryption (e.g., using a private key held by the third party entity). The security provided by such cryptosystems is understood to rely on the theory that it is difficult to factorize the product of two large prime numbers.

In the example of the RSA cryptosystem, an RSA public key comprises two values (herein referred to as the modulus ‘n’ and the public exponent ‘e’). The modulus ‘n’ is the product of two prime numbers, ‘p’ and ‘q’. In some examples, the public exponent ‘e’ is equal to 65537, but may be equal to other values in other examples. An RSA private key comprises a private exponent, ‘d’. The prime numbers ‘p’ and ‘q’, and the private exponent ‘d’ are kept private.

To provide sufficient security, RSA keys may be large. An example key size is 2048 bits (i.e., the modulus ‘n’ and the private exponent ‘d’ are each 2048 bits). In such an example, the prime numbers ‘p’ and ‘q’ may each have a size of about 1024 bits. In some examples, RSA keys may have different sizes such as 3072 and 4096 bits.

As discussed above, in order to generate an RSA key within a specified timeframe, a computing device is provided with certain specifications. A computing device with processing power limitations may be slow to generate large prime numbers (which may be used to provide a specified security level) since the prime number generation procedure is iterative and may involve multiple iterations of the procedure before a verified prime number is identified.

The stages of an example RSA key generation procedure (which comprises a prime number generation/identification procedure) implemented by a computing device are described below.

Stage 1. The public exponent ‘e’ and a private seed (e.g., a random value assigned to the computing device) is specified as an input to the key generation procedure. In some examples, a ‘label’ can be set, which may specify the cryptographic operation that the key is to be used for (e.g., encryption or signing) and/or the label may be indicative of a protocol the key is used for, a version number of an operating system, or any other information that may be used.

Stage 2. A counter (which may define an iteration number), which may be referred to as ‘outer’ is set to 0. In some examples, additional counter values may be set.

Stage 3. Candidate first and second prime number values ‘p’ and ‘q’ are set to 0.

Stage 4. The ‘outer’ counter is incremented by 1.

Stage 5. The private seed, the label (if present) and the outer counter are input into a deterministic prime number calculator such as a key derivation function, KDF, or pseudo-random function to generate a first candidate prime number, ‘p’. In some examples, the KDF may implement a hash-based message authentication code (HMAC)-based KDF (HKDF) to generate ‘p’ although other functions may be used.

Stage 6. The first candidate prime number ‘p’ then has its two most significant bits set to one (to ensure it is a large number) and its least significant bit set to one (to ensure it is an odd number).

Stage 7. If the second candidate prime number, ‘q’ is not equal to 0, a check is performed to determine whether the first candidate prime number ‘p’ is a suitable distance from the second candidate prime number ‘q’. If it is, the procedure continues. Else, the procedure returns to Stage 4.

Stage 8. The remainder of ‘p’ mod ‘e’ is then calculated. If the remainder (rem′) of this calculation equals zero (i.e., rem=0), the first candidate prime number is defined according to ‘p’=‘p’+2. If the remainder of this calculation equals one (i.e., rem=1), the first candidate prime number ‘p’ is defined according to ‘p’=‘p’−2. In all other cases, the first candidate prime number is defined according to ‘p’=‘p’. Stage 8 checks that the primes are such that (p−1)(q−1) is coprime to e (i.e., the greatest common divisor is 1).

Stage 9. The first candidate prime number ‘p’ is then checked to see if it is prime. Examples of primality tests include the Miller-Rabin and Lucas primality tests—however, any appropriate primality test may be used. If ‘p’ is not prime, the procedure returns to Stage 4.

Stage 10. However, if ‘p’ is indeed prime, and if ‘q’=0, set q=p and return to Stage 4. Otherwise, if ‘q’≠0, let ‘p’=‘p’ and continue. In other words, once a candidate prime number ‘p’ has been verified as prime, ‘q’ is set as equal to this candidate prime number and the procedure goes to Stage 4 whereupon the subsequent candidate prime number(s) can be tested. Providing ‘q’ has been identified as being prime, candidate prime numbers can be tested until ‘p’ has been identified as being prime also. Certain checks may be performed such as in Stage 7 to determine that ‘p’ and ‘q’ have been appropriately selected.

Stage 11. The modulus ‘n’ is calculated from the product of the two prime numbers (i.e., ‘n’=p*q).

Stage 12. The private exponent ‘d’ is then calculated according to:

d=e\hat{ }(−1)mod(p−1)(q−1),

where ‘e’ is the public exponent.

Stage 13. The RSA private and public keys are thereby generated (i.e., ‘d’ and ‘n’ are the output) along with the verified prime numbers ‘p’ and ‘q’. The modulus ‘n’ (and public exponent ‘e’) is public whereas ‘d’, ‘p’ and ‘q’ are kept private (e.g., they may be stored in a secure environment of the computing device or shared with a trusted entity via a secure channel).

The calculation of the modulus ‘n’ and the private exponent ‘d’ is straightforward once the verified prime numbers ‘p’ and ‘q’ have been identified. However, the generation of ‘p’ and ‘q’ can be time consuming because the procedure may return to Stage 4 multiple times (i.e., ‘iterations’ where the counter value is incremented). Due to the probabilistic nature of the prime number generation procedure, it may not be possible to predict how long it will take to generate the verified prime numbers ‘p’ and ‘q’.

Once the RSA keys have been generated, the computing device may wish to retain or re-generate these keys for future use in certain cryptographic operations. There are two potential ways the computing device may retain or generate the keys.

In some examples, at least the private key ‘d’ (and prime numbers ‘p’ and ‘q’) may be retained (i.e., stored) in a secure environment of the computing device (such as in a TPM). A specified amount of memory may be allocated for storing the RSA keys (e.g., greater than 2048 bits may be allocated for RSA keys of this size). In some examples, multiple RSA keys (for different cryptographic operations) may be stored for future use.

In some examples, the same RSA keys may be re-generated starting from the same private seed as mentioned in Stage 1 above and generating the key in a deterministic manner (e.g., by first identifying a verified prime number as mentioned in stages 5 to 10 above). The prime number re-generation (i.e., re-identification) procedure is deterministic so results in the same output as Stage 13 but the process may be regarded as too slow for certain scenarios due to the probabilistic (and iterative) nature of the prime number re-generation (i.e., re-identification) procedure, depending on the specification (i.e., processing power) of the computing device.

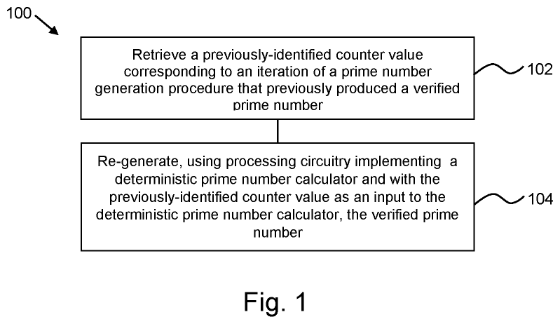

FIG. 1 depicts a flowchart of a method 100, which may be a computer-implemented method of re-generating a prime number (which has been previously identified). In some examples, the method 100 may be implemented in scenarios where the prime number is used for certain cryptographic processes such as key generation. The method 100 may be implemented by a computing device such as a personal computer, smart device such as a phone or tablet, Internet of Things (IoT) device, network node, or any other node of a network of computing devices.

The method 100 comprises, at block 102, retrieving, from a persistent memory, a previously-identified counter value corresponding to an iteration of a prime number generation procedure that previously produced a verified prime number.

In the example prime number identification procedure described above, the counter value is discarded after the prime number(s) have been identified. However, in block 102, the counter value that resulted in the identification of the prime number (i.e., the verified prime number) in a previous prime number identification procedure is stored in the persistent memory. In some examples, the same computing device that initially generated the prime number stores the counter value. In some examples, another computing device that did not initially generate the prime number may store the counter value (e.g., the counter value may have been communicated to the other computing device after being determined elsewhere).

In some examples, the prime number generation (e.g., identification) procedure may have implemented at least part of the example key generation procedure described above (at least to generate a verified prime number). In some examples, the prime number generation procedure may have generated the prime number using a different procedure. In either case, the prime number generation procedure generated the prime number from a counter value indicative of an iteration number of a (probabilistic) prime number identification procedure.

Due to the probabilistic nature of the prime number generation procedure, it is unlikely to be possible to predict the counter value that causes a verified prime number to be generated. By storing the counter value in the persistent memory, the prime number may be rapidly generated, for example, based on the previously-described Stage 5 to avoid having to iteratively implement Stages 5 to 10. In this regard, the method 100 comprises, at block 104, re-generating, using processing circuitry implementing a deterministic prime number calculator and with the previously-identified counter value as an input to the deterministic prime number calculator, the verified prime number.

In some examples, the deterministic prime number calculator may take the input (i.e., the previously-identified counter value) and output the verified prime number. Thus, in contrast to the example prime number identification procedure described above, an iterative procedure for verifying whether a candidate prime number is indeed prime may not be needed. In other similar words, the deterministic prime number calculator may rapidly re-generate the previously-verified prime number since it is known that for the input (i.e., the previously-identified counter value), the prime number can be calculated in a straightforward manner (e.g., without primality testing). In some examples of primality testing, multiple iterations of performing a calculation using the deterministic prime number calculator (e.g., to calculate different candidate prime numbers) may occur before a verified prime number is identified. However, certain methods described herein may avoid the need for primality testing when re-generating a prime number so that the multiple iterations of performing the calculation can be avoided (e.g., the deterministic prime number calculator may be used once since it may be known in advance that the output of the calculator is a previously-identified verified prime number).

In some examples, the deterministic prime number calculator may be implemented as part of the prime number identification procedure (e.g., for initially generating the prime number). For example, the prime number identification procedure may implement both the deterministic prime number calculator (to identify a candidate prime number based on a counter value) and a primality testing procedure (to determine whether or not the candidate prime number is indeed prime).

As mentioned above, the counter value may be discarded. However, by storing this counter value in the persistent memory, it may be possible to rapidly (and deterministically) re-generate the verified prime number without having to perform multiple iterations of a primality testing procedure (which may be implemented as part of a prime number identification procedure such as described above) and/or without having to perform multiple iterations of implementing the deterministic prime number calculator.

In some examples, certain computing device such as TPMs, IoT devices, smart devices such as phones or tables, personal computers, among other computing devices may have limited processing power and/or memory allocated for certain cryptographic operations. The counter value may be a relatively small number such as 32 bits (as compared to the prime numbers, which may in some examples be about 1024 bits). Storing this counter value may reduce the memory that would otherwise be allocated for storing a prime number. Further, upon the prime number being re-generated, less processing power may be allocated for re-generating the prime number since fewer (e.g., a single) iterations of the prime number identification procedure may be implemented (and/or a single iteration of the deterministic prime number calculator may be implemented to re-generate the verified prime number, which in some examples, may avoid the need to perform primality testing again). Certain computing devices may have reduced specifications in terms of processing power and/or memory if the counter value is stored in this manner, which may reduce the cost of such computing devices.

In some examples, the deterministic prime number calculator implemented in block 104 comprises a key derivation function, KDF, that evaluates, using the previously-identified counter value as an input to the KDF, the verified prime number. In some examples, the deterministic prime number calculator may comprise a pseudo-random function, PRF, or any other appropriate function for deterministically calculating the prime number. In some examples, the KDF or PRF (or any other appropriate function) may be implemented for a single iteration to deterministically generate the previously-identified verified prime number. In other similar words, multiple iterations of implementing the KDF or PRF may be avoided since the input to the KDF or PRF may yield the verified prime number as its output after a single iteration of the KDF or PRF.

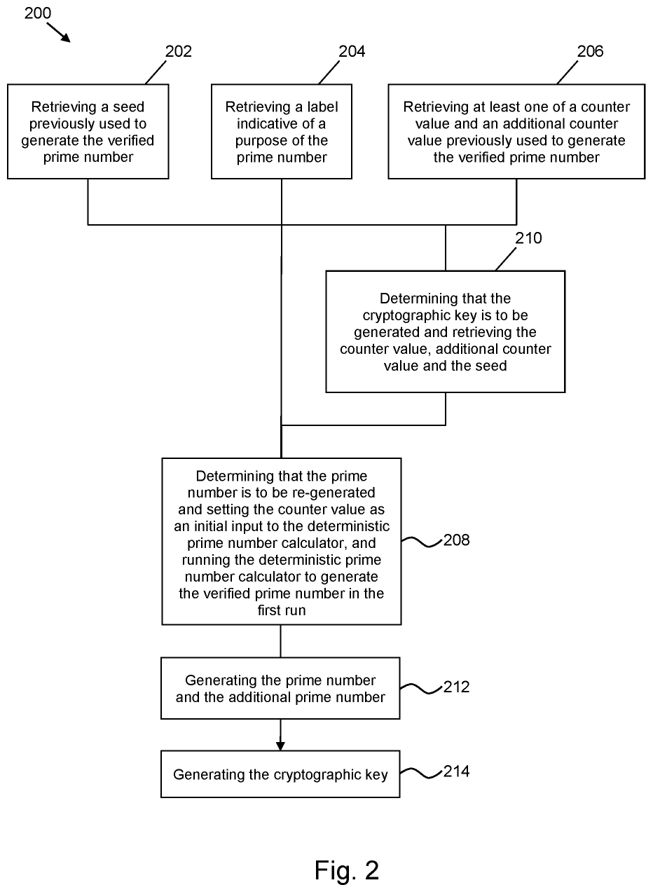

FIG. 2 depicts a flowchart of a method 200, which may be a computer-implemented method of re-generating a prime number (which has been previously identified). The method 200 may be performed in conjunction with the method 100 of FIG. 1.

In some examples, the method 200 comprises, at block 202, retrieving, from the persistent memory, a seed (e.g., the private seed of the previously described Stage 1) previously used to generate the verified prime number in the prime number generation procedure. As will be described in more detail below, in some examples, the method 200 may further comprise re-generating, using the processing circuitry implementing the deterministic prime number calculator and with the previously-identified counter value and seed as an input to the deterministic prime number calculator, the verified prime number.

In some examples, the method 200 comprises, at block 204, retrieving, from the persistent memory, a label indicative of a purpose of the prime number that was previously used to generate the verified prime number. As will be described in more detail below, in some examples, the method 200 may further comprise re-generating, using the processing circuitry implementing the deterministic prime number calculator and with the previously-identified counter value, seed and label as an input to the deterministic prime number calculator, the verified prime number.

In some examples, the method 200 comprises, at block 206, retrieving, from the persistent memory, at least one of the previously-identified counter value and a previously-identified additional counter value previously used to generate at least one of: the verified prime number based on the counter value and an additional verified prime number based on the additional counter value. As will be described in more detail below, the method 200 may further comprise re-generating, using the processing circuitry implementing the deterministic prime number calculator and with the previously-identified counter value, additional previously-identified counter value and seed as an input to the deterministic prime number calculator, the verified prime number and the additional verified prime number.

In some examples, the method 200 comprises, at block 208, upon a determination being made that the prime number is to be re-generated, setting the counter value as an initial input to the deterministic prime number calculator for a first run of the deterministic prime number calculator, and running the deterministic prime number calculator to generate the verified prime number in the first run. In other words, a single iteration/calculation using the deterministic prime number calculator may be used to re-generate the prime number. Thus, in contrast to scenarios where the initial input (i.e., the counter) to the prime number identification procedure is zero (e.g., see Stage 2 described previously) such that multiple iterations of the prime number identification procedure occur before a prime number is identified, the initial input is set as the counter value stored in the persistent memory.

In some examples, the method 200 comprises, at block 210, determining that the cryptographic key is to be generated (or regenerated) and retrieving, from the persistent memory, the counter value, additional counter value and the seed (e.g., at blocks 202 and 206). In some examples, block 210 further comprises retrieving the label (e.g., at block 204). After the determination is made at block 210, the method 200 may proceed to block 208 where the prime number is calculated (e.g., instead of proceeding using the iterative primality testing procedure).

In some examples where the additional prime number is used (e.g., to generate the key), the method 200 comprises, at block 212, calculating the prime number and the additional prime number. The additional prime number may be generated using the same procedure at block 208. In some examples, the prime number may be generated in the first run. The additional counter value may then be set as a (new) initial input to the deterministic prime number calculator. The deterministic prime number calculator may then be implemented to calculator the additional prime number (e.g., in a second run).

In some examples, the method 200 comprises, at block 214, generating, using processing circuitry implementing a cryptographic key generator, a cryptographic key (e.g., an RSA key) comprising a public component (e.g., a public key) and a private component (e.g., a private key). The public component may be generated using the verified prime number and the additional verified prime number (e.g., according to Stage 11 described previously). The private component may be generated using the verified prime number, the additional verified prime number and a public parameter (e.g., the public exponent ‘e’) retrieved from the persistent memory. In some examples, the public parameter may not be used to identify or generate the prime number and the additional prime number, but may instead be used to generate the key.

Referring again to blocks 202 and 206, in some examples, the seed used to generate the verified prime number may be the same seed used to generate the additional verified prime number. Thus, in such examples, the persistent memory may store a single seed. In some examples, two different seeds may be used to generate the prime number and the additional prime number. Storing the single seed may use less memory than storing two different seeds.

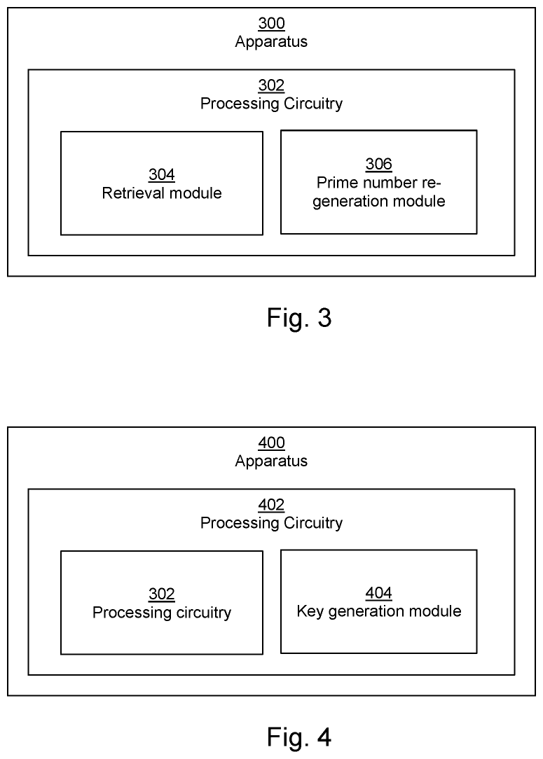

FIG. 3 is a schematic illustration of apparatus 300 for implementing certain methods described herein.

The apparatus 300 comprises processing circuitry 302. The processing circuitry 302 may, for example, carry out blocks of the methods described herein (e.g., method 100 or method 200) and/or execute the instructions stored on a machine readable medium (e.g., comprising instructions for implementing certain methods described herein).

The apparatus 300 comprises a retrieval module 304 to retrieve, from a persistent memory, a previously-identified input iteration number (e.g., counter value) of an iterative prime number identification procedure that previously produced, for the input iteration number, a verified prime number.

The apparatus 300 further comprises a prime number re-generation module 306 to deterministically re-generate, by inputting the previously-identified input iteration number into a deterministic prime number computation function, the verified prime number.

In some examples, the iterative prime number identification (e.g., generation) procedure comprises the deterministic prime number computation function (e.g., a deterministic prime number calculator). In use, the prime number computation function is to deterministically compute a candidate prime number for an input iteration number. In some examples, the iterative prime number identification procedure further comprises an iterative primality testing function for verifying whether the candidate prime number for the input iteration number is prime. In use, the iterative prime number identification procedure is to identify the input iteration number that successfully produces a verified prime number using the deterministic prime number computation function.

FIG. 4 is a schematic illustration of apparatus 400 for implementing certain methods described herein.

The apparatus 400 comprises processing circuitry 402. The processing circuitry 402 may, for example, carry out blocks of the methods described herein (e.g., method 100 or method 200) and/or execute the instructions stored on a machine readable medium (e.g., comprising instructions for implementing certain methods described herein).

The apparatus 400 comprises the processing circuitry 302 of FIG. 3 and further comprises a key generation module 404 to generate a key (e.g., based on the prime number re-generated by the prime number re-generation module 306 of FIG. 3).

In some examples, the retrieval module 304 may, in use, retrieve from the persistent memory, two previously-identified iteration numbers (e.g., the ‘counter value’ and the ‘additional counter value’) of the iterative prime number identification procedure that deterministically generate, based on the two previously-identified iteration numbers, two different prime numbers (e.g., the prime number and the additional prime number).

In some examples, the key generation module 402 is to generate the key (e.g., the cryptographic key) based on the two different prime numbers.

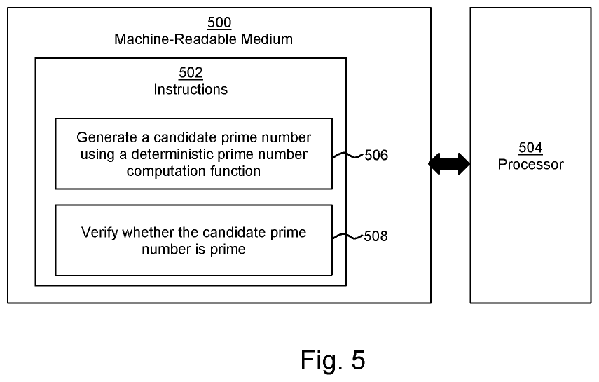

FIG. 5 schematically illustrates a machine-readable medium 500 (e.g., a tangible machine-readable medium) which stores instructions 502, which when executed by at least one processor 504, cause the at least one processor 504 to carry out certain example methods described herein (e.g., the methods 100, 200 described above or any other method that may have been performed prior to the methods 100, 200 being implemented). In some examples described in more detail below, the machine-readable medium 500 may be implemented in a computing device that initially generated a prime number (and in some examples, a cryptographic key). The methods 100 and 200 and the apparatus 300 and 400 may, in some examples, refer to the re-generation of the prime number (and in some examples, a cryptographic key) that was previously identified or generated as a result of the execution of the instructions 502 stored by the machine-readable medium 500.

The instructions 502 comprise instructions 506 to cause the at least one processor 504 to generate a candidate prime number using a prime number computation function (e.g., using a deterministic prime number calculator or deterministic prime number computation function) that uses an input counter value (e.g., a counter value or iteration number) corresponding to an iteration of an iterative prime number identification procedure to deterministically compute the candidate prime number. The instructions 502 further comprise instructions 508 to verify whether the candidate prime number is prime. If the candidate prime number is not verified as being prime, the instructions 508 cause the input counter value to be incremented so that another candidate prime number can be generated using the incremented input counter value and tested for primality. If the candidate prime number is verified as being prime, the instructions cause an indication of the input counter value corresponding to the candidate prime number verified as being prime to be stored in a persistent memory.

In addition to the input counter value, in some examples, the deterministic prime number computation function may use other input values to generate the candidate prime number. In some examples, the other input values may comprise at least one of: a seed, a label, a public exponent ‘e’ and an additional input counter value (e.g., an ‘additional counter value’ or an ‘additional iteration number’).

In some examples, the seed may comprise a random seed (e.g., derived from a source of entropy). The seed may be stored persistently (e.g., in a persistent memory of or accessible to the computing device) and may, in some examples, be kept private. In some examples, the seed may be unique to the computing device. In some examples, the seed may be unique to a manufacturer of the computing device.

In some examples, the label may indicate a purpose of at least one of: the prime number and the key to be generated. Where relating to generation of a key, in some examples, the label may explain the purpose of the key such as ‘encryption’ or ‘signing’. In some examples, the label may comprise any information relating to the purpose of prime number and/or key generation such as the date and/or time the label was derived and/or the name of the computing device's operating system (e.g., software or firmware) version using the label. The label may be stored persistently (e.g., in a persistent memory of or accessible to the computing device). The label may or may not be kept private.

In some examples, the public exponent ‘e’ may be stored persistently (e.g., in a persistent memory of or accessible to the computing device). The public exponent ‘e’ may or may not be kept private.

In addition to the input counter value, in some examples, the additional input counter value may be used to generate the prime number.

Once the prime number(s) have been computed, the input counter value(s) that correspond to those prime number(s) are stored in the persistent memory. The input counter value(s) may or may not be kept private. The actual prime number(s) may not need to be stored in a persistent memory (e.g., to save memory).

Where certain values are stored in the persistent memory, these values may or may not be kept private. In some examples, the input value(s) and/or the label may be integrity protected to prevent manipulation of these values (which would potentially prevent correct regeneration of the prime numbers). In some examples, the seed may be used to generate a message authentication code, MAC, key, which may be used to produce an authenticity tag on the value, which can later be determined based on knowledge of the private seed.

In some examples, the instructions 502 may, in use, cause a key to be generated based on the candidate prime number verified as being prime, and upon receiving an indication that the key is to be discarded, discarding the key. Thus, if the key uses a large amount of memory, the amount of memory used to store the information for re-generating that key (e.g., as part of the methods 100 or 200 or using the apparatus 300 or 400) may be less than the memory space that may otherwise be allocated for storing the key itself.

An example process for generating a key and later re-generating that key is now described.

An input counter value is specified for each candidate prime number ‘p’ and ‘q’. These input counter values may be stored with other input values such as the label and/or the seed.

If, during the key generation, the input counter value that outputs a verified prime number ‘p’ is ‘10’ and the input counter value that outputs a verified prime number ‘q’ is 43, these input counter values are stored in a persistent memory along with any other relevant input values. The prime numbers and/or the corresponding key is not stored in the persistent memory.

When the key is to be re-generated, the prime numbers ‘p’ and ‘q’ are set to zero initially and then re-generated by inputting the input counter values ‘10’ and ‘43’ (along with any other input values) to the deterministic prime number calculator (e.g., by implementing at least one of stages 5, 6 and 8 described previously). In some examples, stages 7 and/or 9 described previously may be implemented. The key is then re-generated by implementing stages 11 to 13 described previously. Multiple iterations of certain stages (i.e., primality testing) may be avoided by directly inputting the input counter values to the deterministic prime number calculator to efficiently generate the prime numbers (e.g., in less time or using less processing resource than in the case of the multiple iteration procedure used in prime number identification procedures).

In some examples, the instructions 502 may, in use, cause an indication of the input counter value to be transmitted to a third party processing device (e.g., another computing device, not shown). The third party processing device may, in use, re-generate the candidate prime number verified as being prime by inputting, to a deterministic prime number computation function implemented by the third party processing device, the input counter value corresponding to the candidate prime number verified as being prime. In some examples, less data may be transferred when transmitting the indication of the input counter value compared with the data that may otherwise be transferred if instead transmitting the prime number. In some examples, indications of other input values may be transmitted to the third party processing device.

In some examples, the indication of the input counter value may be provided as part of visual data encoding such as a matrix code or QR code. A QR code may be displayed on a screen of a first computing device that initially generated the prime number(s) (and in some examples, a cryptographic key). A QR code may be capable of conveying a specified amount of data which may be less than the size of the prime number(s) and/or key. Providing the indication of the input counter value as part of the QR code may allow sufficient information to be provided in the QR code to allow a third party computing device (e.g. a second computing device) to read the QR code and, using its own processing circuitry, re-generate the prime number(s) and/or key (e.g., providing the third party computing device has been pre-programmed with the same prime number generator/prime number identification procedure as the first computing device).

In some examples, the indication of the input counter value may be conveyed (e.g., transmitted) via a channel with constraints such as bandwidth limitations (e.g., Bluetooth™ low energy, infrared, visual (e.g., see the QR code example above) and sound (e.g., audio) channels). Conveying prime numbers and/or keys via such channels may take too long for certain scenarios. However, by conveying the indication of the input counter value via such a channel, the information to allow a receiving entity to re-generate the prime number and/or key may be conveyed in a shorter amount of time compared with conveying the actual prime number and/or key.

Examples in the present disclosure can be provided as methods, systems or as a combination of machine readable instructions and processing circuitry. Such machine readable instructions may be included on a non-transitory machine (for example, computer) readable storage medium (including but not limited to disc storage, CD-ROM, optical storage, etc.) having computer readable program codes therein or thereon.

The present disclosure is described with reference to flow charts and block diagrams of the method, devices and systems according to examples of the present disclosure. Although the flow charts described above show a specific order of execution, the order of execution may differ from that which is depicted. Blocks described in relation to one flow chart may be combined with those of another flow chart. It shall be understood that each block in the flow charts and/or block diagrams, as well as combinations of the blocks in the flow charts and/or block diagrams can be realized by machine readable instructions.

The machine readable instructions may, for example, be executed by a general purpose computer, a special purpose computer, an embedded processor or processors of other programmable data processing devices to realize the functions described in the description and diagrams. In particular, a processor or processing circuitry, or a module thereof, may execute the machine readable instructions. Thus functional modules of the apparatus 300, 400 (for example, the retrieval module 304, prime number re-generation module 306 and/or the key generation module 404) and devices may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate array etc. The methods and functional modules may all be performed by a single processor or divided amongst several processors.

Such machine readable instructions may also be stored in a computer readable storage that can guide the computer or other programmable data processing devices to operate in a specific mode.

Such machine readable instructions may also be loaded onto a computer or other programmable data processing devices, so that the computer or other programmable data processing devices perform a series of operations to produce computer-implemented processing, thus the instructions executed on the computer or other programmable devices realize functions specified by block(s) in the flow charts and/or in the block diagrams.

Further, the teachings herein may be implemented in the form of a computer program product, the computer program product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the scope of the present disclosure. It is intended, therefore, that the method, apparatus and related aspects be limited by the scope of the following claims and their equivalents. It should be noted that the above-mentioned examples illustrate rather than limit what is described herein, and that many implementations may be designed without departing from the scope of the appended claims. Features described in relation to one example may be combined with features of another example.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A method comprising:
retrieving, from a persistent memory, a previously-identified counter value corresponding to an iteration of a prime number generation procedure that previously produced a verified prime number; and
re-generating, using processing circuitry implementing a deterministic prime number calculator and with the previously-identified counter value as an input to the deterministic prime number calculator, the verified prime number.

2. The method of claim 1, where the deterministic prime number calculator comprises a key derivation function, KDF, that evaluates, using the previously-identified counter value as an input to the KDF, the verified prime number.

3. The method of claim 1, comprising:
upon a determination being made that the prime number is to be re-generated, setting the counter value as an initial input to the deterministic prime number calculator for a first run of the deterministic prime number calculator, and running the deterministic prime number calculator to generate the verified prime number in the first run.

4. The method of claim 1, comprising:
retrieving, from the persistent memory, a seed previously used to generate the verified prime number in the prime number generation procedure; and
re-generating, using the processing circuitry implementing the deterministic prime number calculator and with the previously-identified counter value and seed as an input to the deterministic prime number calculator, the verified prime number.

5. The method of claim 4, comprising:
retrieving, from the persistent memory, a label indicative of a purpose of the prime number that was previously used to generate the verified prime number in the prime number generation procedure; and
re-generating, using the processing circuitry implementing the deterministic prime number calculator and with the previously-identified counter value, seed and label as an input to the deterministic prime number calculator, the verified prime number.

6. The method of claim 4, comprising:
retrieving, from the persistent memory, a previously-identified additional counter value used to generate an additional verified prime number in the prime number generation procedure; and
re-generating, using the processing circuitry implementing the deterministic prime number calculator and with the previously-identified counter value, previously-identified additional counter value and seed as an input to the deterministic prime number calculator, the verified prime number and the additional verified prime number.

7. The method of claim 6, where the seed used to generate the verified prime number is the same seed used to generate the additional verified prime number.

8. The method of claim 6, comprising generating, using processing circuitry implementing a cryptographic key generator, a cryptographic key comprising a public component and a private component, where the public component is generated using the verified prime number and the additional verified prime number and the private component is generated using the verified prime number, the additional verified prime number and a public parameter retrieved from the persistent memory.

9. The method of claim 8, comprising:
upon a determination being made that the cryptographic key is to be generated, retrieving, from the persistent memory, the previously-identified counter value, previously-identified additional counter value and the seed;
re-generating, using the processing circuitry implementing the deterministic prime number calculator and with the previously-identified counter value, previously-identified additional counter value and seed as an input to the deterministic prime number calculator, the verified prime number and the additional verified prime number;
generating, using the processing circuitry implementing the cryptographic key generator, the cryptographic key.

10. Apparatus comprising processing circuitry, the processing circuitry comprising:
a retrieval module to retrieve, from a persistent memory, a previously-identified input iteration number of an iterative prime number identification procedure that previously produced, for the input iteration number, a verified prime number; and
a prime number re-generation module to deterministically re-generate, by inputting the previously-identified input iteration number into a deterministic prime number computation function, the verified prime number.

11. The apparatus of claim 10, where the iterative prime number identification procedure comprises:
the deterministic prime number computation function, where the prime number computation function is to deterministically compute a candidate prime number for an input iteration number; and
an iterative primality testing function for verifying whether the candidate prime number for the input iteration number is prime, and where the iterative prime number identification procedure is to identify the input iteration number that successfully produces a verified prime number using the deterministic prime number computation function.

12. The apparatus of claim 10, comprising a key generation module to generate a key, where:
the retrieval module is to retrieve, from the persistent memory, two previously-identified iteration numbers of the iterative prime number identification procedure that deterministically generate, based on the two previously-identified iteration numbers, two different prime numbers; and
the key generation module is to generate the key based on the two different prime numbers.

13. A tangible machine-readable medium storing instructions, which when executed by at least one processor, cause the at least one processor to:
generate a candidate prime number using a deterministic prime number computation function that uses an input counter value corresponding to an iteration of an iterative prime number identification procedure to deterministically compute the candidate prime number; and
verify whether the candidate prime number is prime, where:
if the candidate prime number is not verified as being prime, the instructions cause the input counter value to be incremented so that another candidate prime number can be generated using the incremented input counter value and tested for primality; or
if the candidate prime number is verified as being prime, the instructions cause an indication of the input counter value corresponding to the candidate prime number verified as being prime to be stored in a persistent memory.

14. The tangible machine-readable medium of claim 13, where the instructions are to cause a key to be generated based on the candidate prime number verified as being prime, and upon receiving an indication that the key is to be discarded, discarding the key.

15. The tangible machine-readable medium of claim 13, where the instructions are to cause an indication of the input counter value to be transmitted to a third party processing device, where the third party processing device is to re-generate the candidate prime number verified as being prime by inputting, to a deterministic prime number computation function implemented by the third party processing device, the input counter value corresponding to the candidate prime number verified as being prime.
